(19) United States
(12) Patent Application Publication
(10) Pub. No.: US 2002/0066780 A1
(43) Pub. Date: Jun. 6, 2002

(54) Voting systems and methods

(76) Inventor: Shiraz Balolia, Bellingham, WA (US)

Correspondence Address: MICHAEL R. SCHACHT, HUGHES & SCHACHT, P.S., SUITE 1, 2801 MERIDIAN STREET, BELLINGHAM, WA, 98225-2412, US

(21) Appl. No.: 09/728,632

(22) Filed: Dec. 1, 2000

(51) Int. Cl. G06C 23/00

(52) U.S. Cl. 235/51

(57) ABSTRACT

A voting system for allowing voters to select one of a plurality of choices associated with at least one race associated with an election. The voting system comprises a blank ballot form, a blank tabulation form, and a kiosk system. A blank ballot form is issued to each voter. The kiosk system comprises an output device, an input device, a tabulation system, a memory device, and a printer. The blank tabulation form is associated with the kiosk system. The memory device stores race data and choice data associated with the choices and races of the election, selection data, and tabulation data. The output device is controlled to communicate the race data and the choice data to the voters. The input device is controlled to receive the selection data from the voters. The tabulation system generates the tabulation data associated with the kiosk system based on the selection data. The printer generates completed ballot forms by printing the selection data of each voter on the blank ballot form issued to each voter and a completed tabulation form by printing the tabulation data generated for the kiosk system on the blank tabulation form. The selection data on the completed ballot forms and tabulation data on the completed tabulation forms may be compared to audit results of the election.

### RELATED APPLICATIONS

This application claims priority of U.S. Provisional Patent Application Attorneys' Ref. No. P213401 (Serial No. has not been assigned) which was filed on Nov. 22, 2000, and U.S. Provisional Patent Application Attorneys' Ref. No. P213404 (Serial No. has not been assigned) which was filed on Nov. 27, 2000.

### TECHNICAL FIELD

The present invention relates to systems and methods for allowing voters to cast a vote and, more particularly, to systems and methods that are highly accurate and create auditable results.

### BACKGROUND OF THE INVENTION

For the purposes of the following discussion, the term “race” will refer to a contest between two or more candidates for office or between two or more positions on an issue. The term “election” will refer to the process of allowing voters to select candidates and positions and tabulating these selections to determine the winner in each of the races involved in the particular election. The exact rules governing the conduct of an election will vary from jurisdiction to jurisdiction. The following discussion will thus describe the present invention and background thereof in general terms, with the understanding that a specific implementation of the present invention may vary depending upon the jurisdiction.

In many situations, elections are conducted using anonymous votes. Anonymous votes allow voters to make a selection on a candidate or issue in confidence. However, the accuracy of an anonymous vote cannot be directly verified. The only way to ensure confidence in the outcome of an election conducted using anonymous votes is through the integrity of the election process and, more specifically, the voting systems and methods used to carry out the election process.

Any election process will have a margin of error. In most cases, conventional voting systems and methods yield a margin of error that is acceptably lower than the difference between the vote totals of the choices in a race. In such cases, the margin of error is irrelevant.

In rare cases, the difference between the vote totals is sufficiently small that the margin of error may be significant. Many jurisdictions thus require an automatic recount when the difference between the vote totals does not exceed a predetermined threshold.

The use of a recount relies at least in part on the inherent accuracy of the voting systems and methods. Inherent inaccuracies in conventional voting systems and methods may frustrate the recount process and undermine confidence in the election results.

The most obvious example of the failure of conventional voting systems and methods in close races is the 2000 presidential election. The winner of Florida's electoral college votes will win the presidential election. The margin of victory in Florida's is much lower than the margin of error inherent in the voting systems and methods used in Florida The inherent liabilities of these voting systems and methods create a margin of error significantly higher than the difference between the vote totals of the leading candidates. In addition, these voting systems and methods have inherent inaccuracies that delay the recount process and render the overall margin of error, even after the recount process, significantly higher than the difference in the vote totals.

In particular, the Florida process uses a ballot system that employs a paper ballot in which are formed an array of relief cuts or perforations that define rectangular ballot portions referred to as chad. Individual chad may be individually identified by unique numbers. In addition, the absence of an individual chad at a particular location in a larger grid defined by the ballot form can be detected. This type of ballot system will be referred to herein as a punch card system.

When using a punch card system, a voter typically inserts the ballot form under a voting template formed by a sheet, pamphlet, or booklet that identifies races and choices. Holes are formed in the voting template adjacent to particular choices. The voting template is indexed relative to the ballot form such that holes in the voting template are located above an appropriate chad defined by the ballot form. The user inserts a punch through the hole in the voting template adjacent to the choice to be selected. The punch engages the chad associated with the desired choice. In theory and in most cases in practice, the relief cuts allow the chad to be punched out of the ballot form. The absence of a particular chad in a ballot form thus corresponds to a selection made by the voter. The ballot form is then run through an optical reader that detects the missing chad at particular locations to tabulate voter selections.

The problems with punch card voting systems and methods are numerous. First, the use of the punch requires good vision and decent manual dexterity to make the desired selection accurately. Second, this system allows the voter to select two choices in a particular race, which normally invalidates the vote. Third, the selection is not verified, and if a selection is wrongly made, the chad is removed and cannot be restored. Fourth, the chad may not be completely removed, and thus the selection will not be correctly counted by the optical counting machine. Fifth, the average voter will be able to review the ballot card to ensure that the selection was accurately and unambiguously made; and anyone conducting a manual recount must closely inspect the ballot form to determine the selection, significantly slowing down the recount process. Sixth, once the selection is made, the punch card system does not allow for an audit of the election results other than a recount.

For these and other reasons, the need exists for improved voting systems and methods.

### SUMMARY OF THE INVENTION

These and other objects are obtained by the present invention, which is a voting system for allowing voters to select one of a plurality of choices associated with at least one race associated with an election. The voting system comprises a blank ballot form, a blank tabulation form, and a kiosk system. A blank ballot form is issued to each voter. The kiosk system comprises an output device, an input device, a tabulation system, a memory device, and a printer. The blank tabulation form is associated with the kiosk system.

The memory device stores race data and choice data associated with the choices and races of the election, selection data, and tabulation data. The output device is controlled to communicate the race data and the choice data to the voters. The input device is controlled to receive the selection data from the voters. The tabulation system generates the tabulation data associated with the kiosk system based on the selection data. The printer generates completed ballot forms by printing the selection data of each voter on the blank ballot form issued to each voter and a completed tabulation form by printing the tabulation data generated for the kiosk system on the blank tabulation form. The selection data on the completed ballot forms and tabulation data on the completed tabulation forms may be compared to audit results of the election.

### BRIEF DESCRIPTION OF THE DRAWINGS

FIG. 1 is a perspective view of a voting kiosk system that may be used as part of the present invention;

FIG. 2 is block diagram view depicting components, some of which may be optional under certain circumstances, of the voting kiosk system depicted in FIG. 1;

FIG. 3 is a flow chart depicting an exemplary voting process from the perspective of the voter;

FIG. 4 depicts an exemplary completed ballot form that may be used as part of the present invention;

FIG. 5 flow chart depicting the operation of the voting software loaded on the voting kiosk depicted in FIG. 1;

FIG. 6 is a flow chart depicting an exemplary tabulation process;

FIGS. 6A and 6B are optional steps that may be incorporated, separately or alone, into the exemplary tabulation process depicted in FIG. 6;

FIGS. 7A and 7B are exemplary completed tabulation forms that may be used as part of the present invention;

FIGS. 8A and 8B are flow charts depicting optional ways of creating race data and the loading of the race data into the voting kiosk of FIG. 1 to run the voting software depicted in FIG. 5.

### DETAILED DESCRIPTION OF THE INVENTION

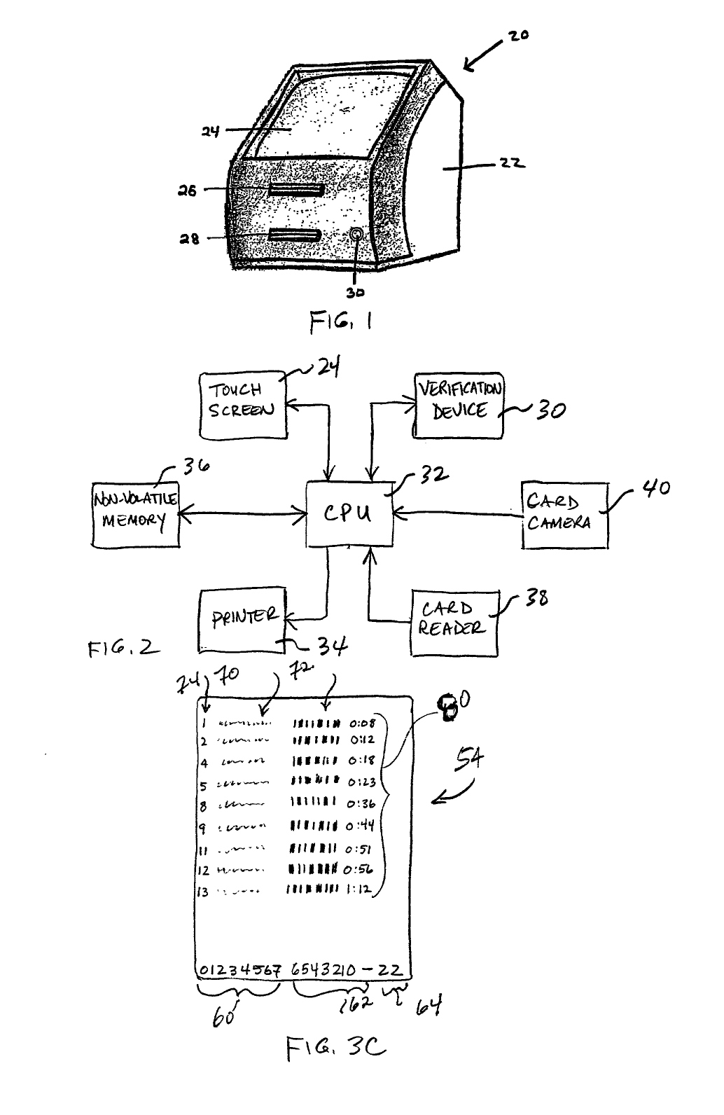

Referring initially to FIG. 1, depicted 24-40 therein at 20 is an exemplary voting kiosk system that may be used as part of the present invention. The voting kiosk system 20 comprises a housing 22, a touch screen 24, a card input slot 26, a card output slot 28, and a verification device 30. The touch screen 24, card input slot 26, card output slot 28, and verification device 30 are mounted to the housing 22 such that they are easily viewed and/or accessed by the user of the kiosk system 20.

In the following discussion, the term “race” refers to a position or issue on which the voter is to vote using the system 20. For example, a race may be a contest for elected office for which one or more candidates are running. A race may also be a specific ballot issue such as a referendum, proposition, initiative, or the like. Each race presents the user with what will be referred to herein as a number of “choices”. The choices may be candidates names, positions on issues, and the like. The voter may make what will be referred to herein as a “selection” when presented with one or more choices associated with a particular race. Normally, one selection is made per race, but some races may allow several selections to be made.

In the following discussion, several types of people will be considered users of the voting kiosk system 20. For example a voter will be the primary user of the kiosk system 20. A precinct captain or other individual with the authority to set up the kiosk system 20, monitor voting, tabulate votes, or the like will be referred to herein as a supervisor. The supervisor, who will often be a volunteer, is normally associated with a specific polling place and is responsible for a limited number of kiosk systems 20.

The overall voting systems and methods of the present invention may further include an election overseer and an election auditor. The election overseer will most likely be a state employee and is responsible for determining election wide issues such as which races qualify for the ballot, which candidates qualify for the races, the wording of race and candidate descriptions and the like, and order of the races and candidates. The election auditor may be the election overseer, political party representative, or the like who is responsible at least in part for auditing and verifying election results or monitoring the process of auditing and verifying the election results. The overseen and auditor will in the normal course of events not be a direct user of the voting kiosk system 20, except perhaps to test individual systems to determine whether they are operating properly. The election overseer will proscribe certain parameters of the kiosk system 20 to ensure uniformity across all voting places. The election auditor will normally review individual ballot forms and tabulation forms, either directly or by use of a optical counting machine, to check and verify election results.

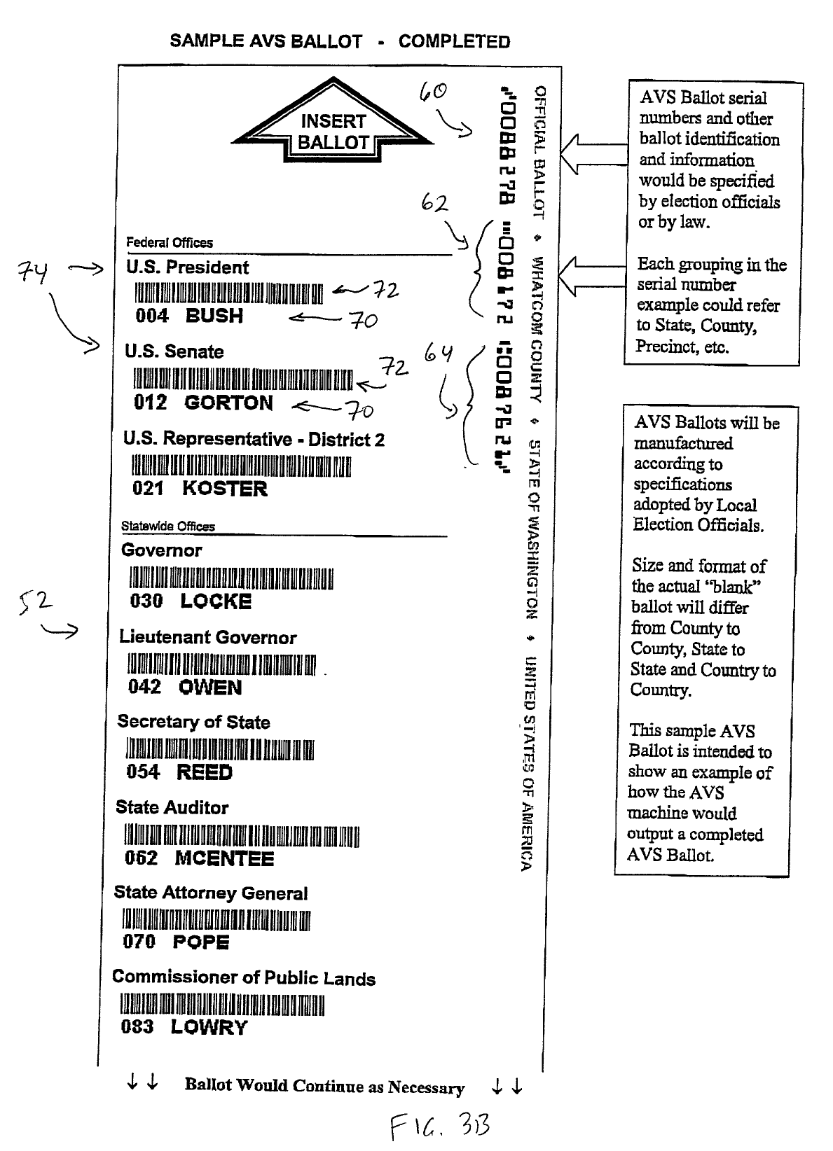

Referring now back to the system 20, an important component of the systems and methods of the present invention is the use of a ballot form. The ballot form starts out blank and is initially referred to as a blank ballot form 50 (FIG. 3A). After the voter votes, the ballot form is altered such that it now contains voting information; once the ballot form contains voting information, the ballot form will be referred to as a completed ballot form 52 (FIG. 3B). Another example of a completed ballot form is depicted at 54 in FIG. 3C. Shown at 60 in FIGS. 3A, 3B, and 3C is a unique serial number identifying the particular blank ballot form. Although the ballot form forms an important part of the present invention, the exact format or layout of the ballot form is not important. Several different exemplary completed ballot forms will be described herein with the understanding that other formats or layouts may be used within the context of the present invention.

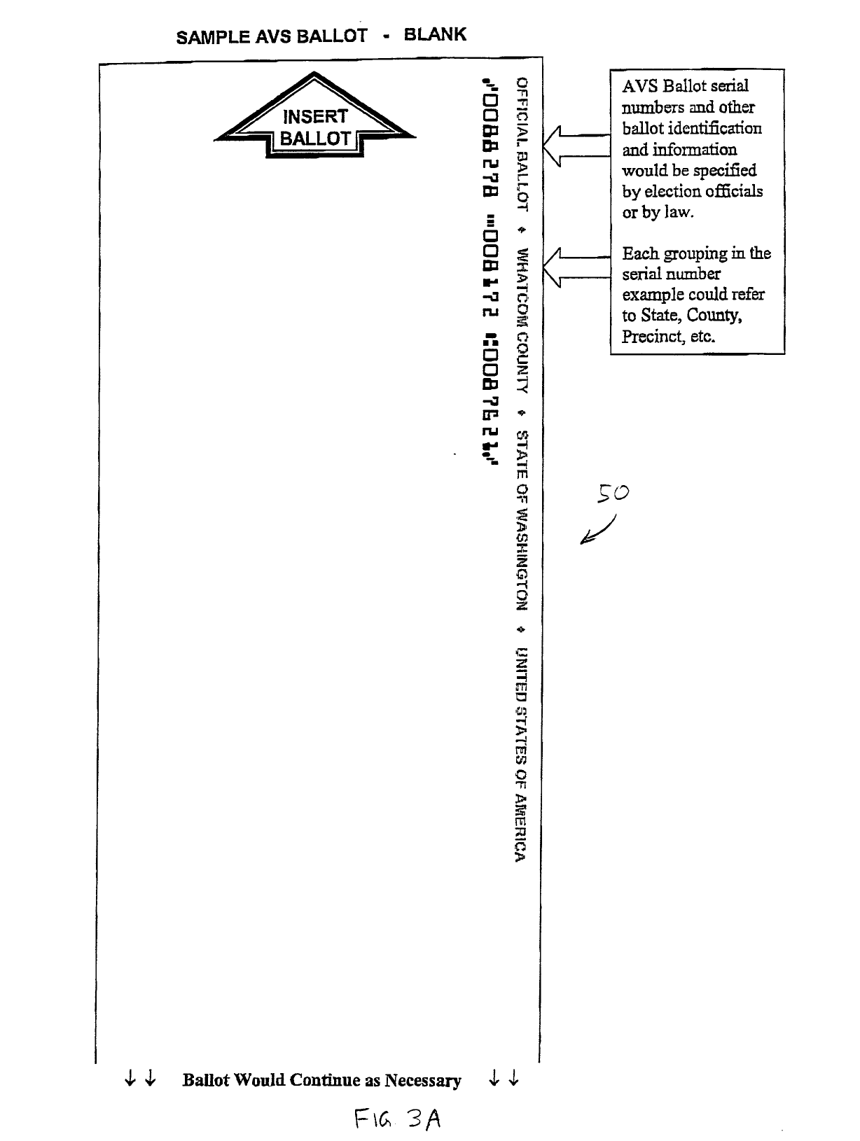

The voting kiosk system 20 is depicted in further detail in FIG. 2. FIG. 2 illustrates that the exemplary kiosk system 20 additionally comprises a central processor 32, a printer 34, non-volatile memory 36, a card reader 38, a card camera 40, and a sound subsystem 42. The individual components 22-42 of the kiosk system 20 are conventional and will not be described in further detail herein beyond the extent necessary for a complete understanding of the present invention.

Additionally, certain of the components 22-42 are not essential to implement the present invention in its broadest form. The card reader 38, card camera 40, and sound subsystem 42 are, for example, optional, but allow for additional authentication of the blank ballot form, verification of the completed ballot form, and/or input and output by users with disabilities or the like. Alternatively, in some situations the optional sound subsystem may obviate the need for a display screen if a voice input system is used.

The components selected for use by the kiosk system 20 and the exact design of the system 20 are not critical to the implementation of the present invention. However, the kiosk system is preferably a modular system that employs industry standard components. By packaging these components in a modular system, it may be possible for repairs to be made on site during an election. The use of industry standard components reduces cost, however, and it may be possible that the kiosks may be configured to be cheap enough to have spare kiosks at the voting place or nearby in the case of a failure of even one component of an individual kiosk.

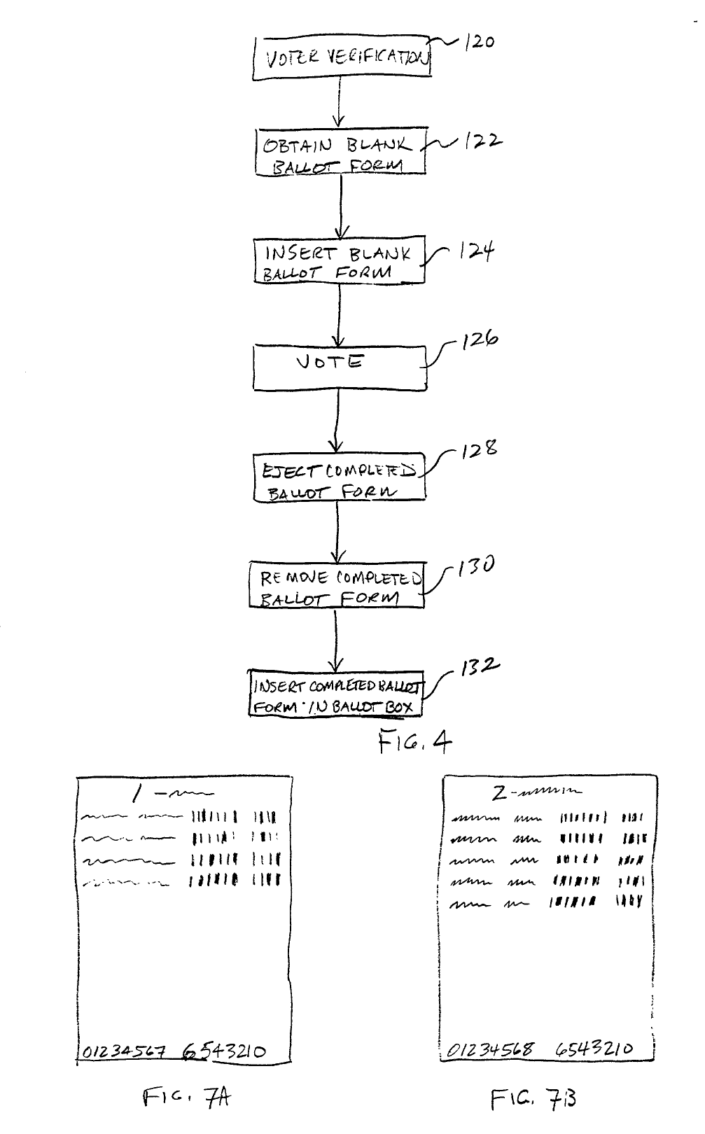

Referring now to FIG. 4, the voting process will now be described from the perspective of the user being a voter. In particular, as shown at step 120, upon entering the polling place the voter is verified and, as shown at step 122, is given a blank ballot form. This first and second steps 120 and 122 are or may be conventional and will not be described herein in further detail.

The voter then approaches voting kiosk system and, as shown at step 124, inserts the blank ballot form 50 into the card input slot 26. The voter then goes through the voting process, which will be described in further detail below, as shown at step 126. When the voting process is completed, the completed ballot form 52 is ejected at step 128 through the ballot output slot 28. The voter then removes the completed ballot form 52 from the kiosk system 20 as shown at step 130 and deposits the completed ballot form 52 in a conventional ballot box (not shown) at step 132.

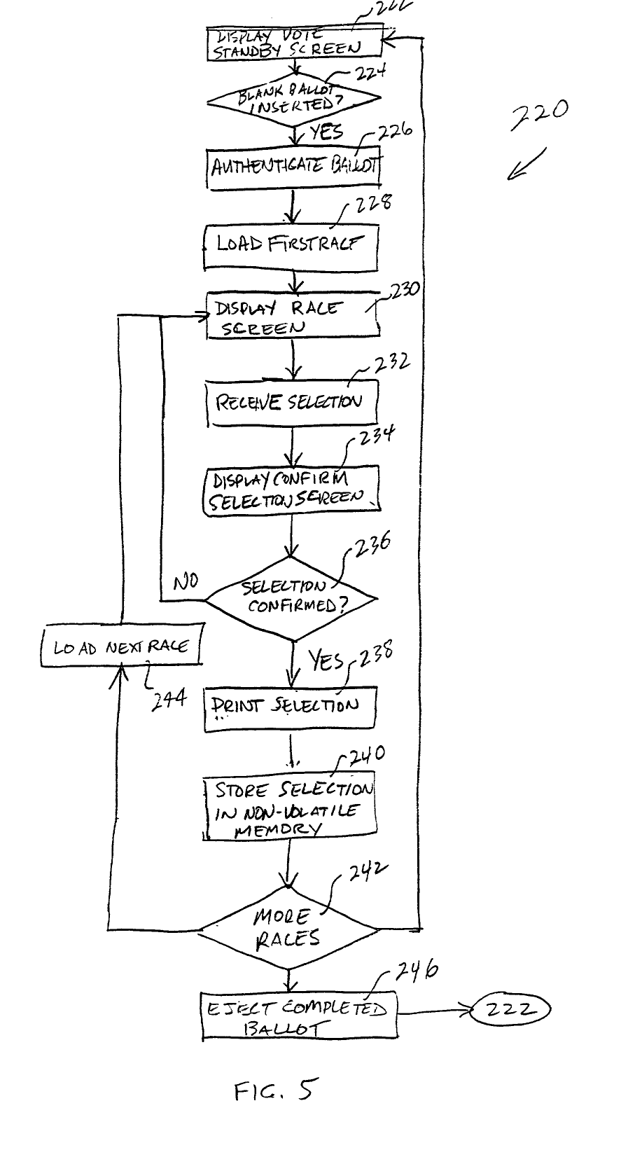

Referring now to FIG. 5, the voting process of step 126 will now be described in further detail. The exemplary voting process 126 is implemented in the form of a voting software program 220 that is run by the kiosk central processor 32. The central processor 32 is conventional and comprises memory for storing the software program 220 and a microprocessor capable of running the software program 220. The central processor 32 also contains conventional hardware for sending data to, receiving data from, and/or controlling the components 24-42. The kiosk system 20 is operating in what will be referred to as its voting mode when the voting software program 220 is running.

The first step of the voting process step 126 is to display a standby screen as shown at 222 while waiting for the next voter. The program 220 waits for an interrupt signaling that a blank ballot form 50 is inserted into the card input slot 26. Once the blank ballot form 50 is inserted, the program performs the optional step of authenticating the ballot as shown at 226.

The authentication step can be as simple as using a mechanical switch that is opened or closed as appropriate by contact or lack of contact with a predetermined portion of the blank ballot form 50. For example, a uniquely placed or shaped notch or hole may be formed in the blank ballot form 50. A more complex authentication process is to use the optional card reader 38 to read the blank ballot form 50 and check for a valid code and/or serial number on the form 50. The authentication step 226 is optional because the completed ballot forms are kept and may be authenticated during the auditing process if necessary.

After the ballot 50 is authenticated, the race data associated with a first race is loaded at step 228. After the first race data is loaded, a race screen associated with the first race data is presented as illustrated at step 230. The race screen displays data such as the title of the race, candidates, and the like. In the exemplary kiosk system 20, the race data may be presented visually on the screen 24 and/or audibly on the sound subsystem 42. In addition, the race data may be presented in any one of a number of approved languages, visually and/or audibly. While the voter's selection of language may be made at any point in the voting process, this selection is preferably first presented immediately before or after, or perhaps in place of, the ballot authentication step 226.

The exemplary screen 24 is a touch screen that allows the voter to communicate a selection to the central processor 32 by touching a portion of the screen 24 corresponding to the selection. Other data input devices such as computer mice, keyboards, keypads, eye tracking systems, voice input systems, and the like may be used to accept input from the voter, but touch screen technology is widely available, relatively advanced, inexpensive, stable, and easy to use for most people.

Any jurisdiction may decide to furnish its voting places with two types of voting kiosks. A first type may be a relatively simple device comprising only the minimum components necessary for a person without disabilities to make a selection. For example, the first type of kiosk may not have a sound subsystem, eye tracking system, keyboard, and/or voice recognition system. The voter using this first type of voting kiosk thus must be able to read the instructions on the screen 24 and make appropriate selection by touching the screen 24 at predetermined locations.

A second type of voting kiosk, referred to as an enhanced kiosk, would include one or more of the sound subsystems, eye tracking systems, keyboard, and/or voice input systems as input and/or output devices in addition to or instead of the input and output devices used by the first type of kiosk. The enhanced kiosk system would allow voters who are not capable of reading instructions on the screen 24 and/or touching the screen 24 at a predetermined location to make the desired selection. For example, a voter with poor eyesight may not be able to read the screen 24 and/or make selections by touching the screen 24.

The enhanced voting kiosk would allow a voter with disabilities to make selections in response to choices using one or more of the sound subsystems, eye tracking systems, keyboard, and/or voice input systems. For example, a voter with poor eyesight or limited motor control may listen to lists of races and/or candidates and respond by saying “yes”, “no”, “skip”, “confirm” or the like into a microphone in response to the audible prompts.

The selection made at step 232 may be made in any number of ways (e.g., touch screen, eye tracking, voice input) in response to any number of stimulus, visible or audible (e.g., screen, sound subsystem). In addition, for privacy, the sound subsystem may use headphones instead of speakers audible to voters in adjacent kiosks. The kiosk may be placed in an enclosed booth to present more privacy to voters using the voice input system, but sufficient privacy may be provided by requesting a generic response (e.g., “yes” or “no”) in response to an audible question presented over headphones (e.g., “VOTE FOR JOHN SMITH FOR GOVERNOR, SAY YES OR NO”).

Once the selection is received as shown at step 232, a confirm selection screen 234 is displayed that presents selection data requesting that the voter confirm the selection just made. For example, the confirm selection screen 234 might ask “PLEASE CONFIRM THAT YOU HAVE VOTED FOR GEORGE W. BUSH FOR U.S. PRESIDENT”. If the selection is not confirmed by touching an appropriate portion of the screen 24, the program returns to step 230 and the display race screen is displayed again. The voter may then re-enter the correct selection at step 232 and confirm the selection at step 234. Again, the confirmation step 234 may be presented using any visual or audible prompt and appropriate data input system as described above.

Once the selection is confirmed, the selection is printed on the ballot form at step 238. The printing employs indelible ink and presents the selection in plain language and/or using a bar code. The ink may further be colored or contain other markers that may be associated with individual kiosks or kiosks operated by a particular jurisdiction. Referring again to FIGS. 3A, 3B, and 3C, an election/precinct identifier 62 may also be printed on the form 54, as well as a number 64 associated with a particular kiosk system 20. The selection data is printed in plain language at 70 and in bar code at 72 as shown in FIGS. 3B and 3C. The race number or data may be printed on the form as shown at 74. And as shown at 80 in FIG. 3C, elapsed time between selections may be printed on the form to provide an enhanced audit trail.

If the optional ballot form camera 40 is used, at least a portion of the actual form may be displayed on the screen to provide the voter with visual confirmation of the voter's selection. The selection data is also stored in the non-volatile memory 36 as shown at step 240. The storage of the voter's selection data may be accomplished by simply incrementing a number associated with a given choice in a given race or by storing a record for each voter containing that voter's selections; the record may then be accessed for a subsequent tabulation of votes.

The program 220 keeps track of the total number of races and the number of races for which selection has been made. If the voter has not made a selection for all of the races, as shown at step 242 the program will load the next race and return to step 230 where the race screen for the next race is displayed. The voter next goes through the selection, confirmation, printing, and storing steps for the next race. This process is repeated until a selection has been made for all of the races.

In each race screen, a provision may be made for the voter to skip that race by touching an appropriate portion of the screen. If the voter skips a race, that selection can be confirmed at step 236, printed on the ballot form at step 238, and stored in non-volatile memory as shown at 240 in the same manner. However, it may be that the system may skip the printing and storage steps and move directly to step 242 to determine if more races exist. In this case, the completed ballot will not contain an entry for a given race as shown in the exemplary completed ballot 54.

After selections have been made for all of the races, the completed ballot is ejected through the ballot output slot 28 as shown at step 246. The system then returns to the display vote standby screen at step 222 and awaits the next voter.

Given the foregoing description, it should be apparent that the software program 220 may be embodied in a number of forms different from that disclosed above. For example, rather than printing the form after each selection is made, the selections may be stored in a record containing all of the selections for the given voter; the entire record may be printed at one time after selections have been made for all of the races. In this case, the voter may be provided with the opportunity to review all of his or her selections and modify any incorrect selections or accept the selections as made. The completed ballot form is then printed.

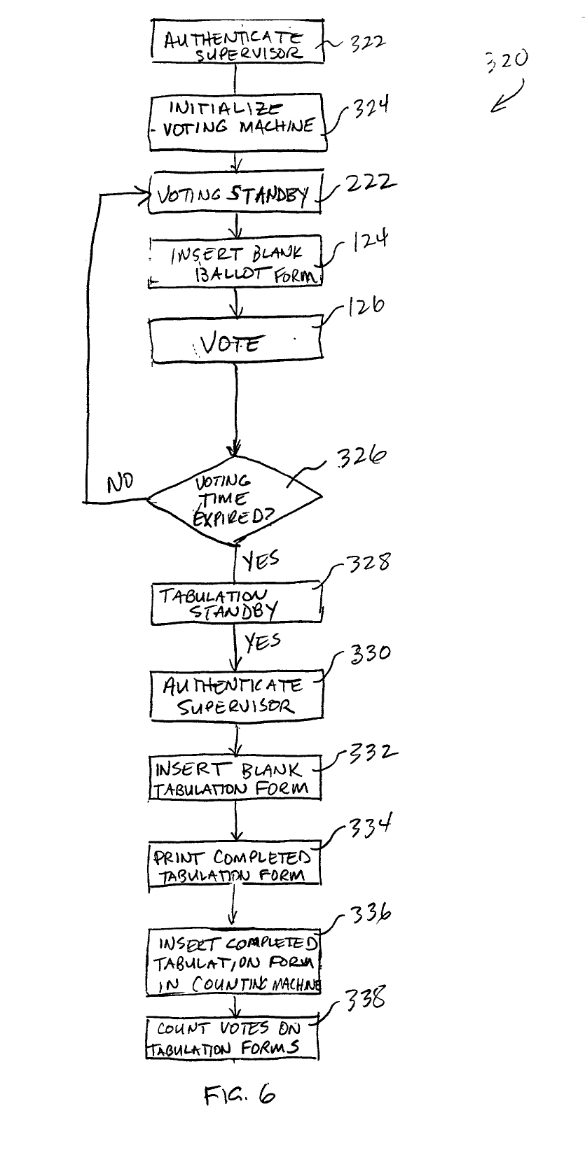

Referring now to FIG. 6, depicted therein is a supervisor control program 320 at least part of which is formed by software that runs on the kiosk system 20. The exemplary control program 320 allows a supervisor to set up the kiosk system 20 at the beginning of the voting day and to tabulate the results at the end of the voting day.

In particular, first thing in the morning the supervisor turns on the kiosk 20 and performs an authentication step as shown at 322 in FIG. 6. The authentication step 322 requires, for example, the supervisor to turn a key in the lock 30, put their finger on a fingerprint identifier, and/or enter a password.

The supervisor next starts an initialization routine at step 324 that ensures that all data previously stored on the non-volatile memory 36 is erased so that the tabulation process is accurate. Alternatively, this initialization routine may be made when the race and candidate data is entered into the kiosk system 20 as described below. After the kiosk system 20 is initialized as shown at step 324, it enters the voting standby state 222. The system 20 is then used to perform the voting steps 124 and 126 until, at step 326, the system 20 determines that the time for voting has expired. This step 326 may be performed by a combination of hardware and software or externally by the supervisor.

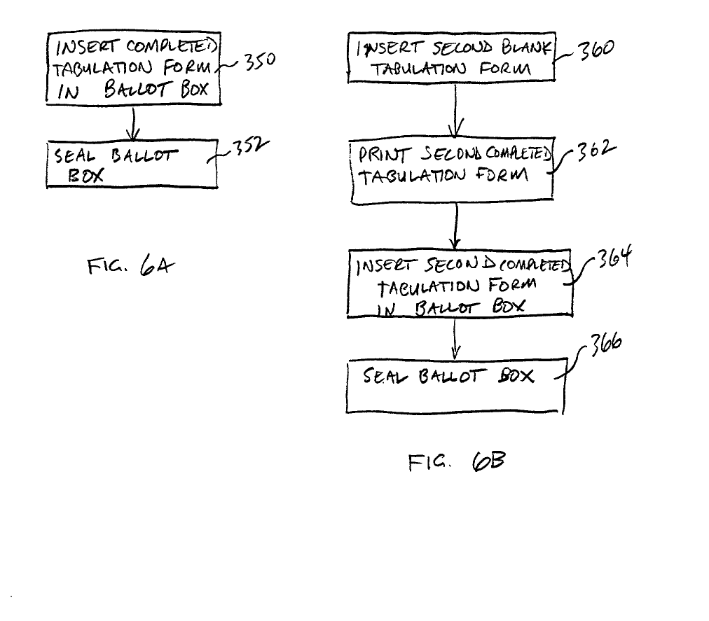

Once the step 326 determines that no additional voting is allowed, the system 20 enters a tabulation standby mode as shown at step 328. The system 20 again authenticates at step 330 that the supervisor is authorized to run the control program 320. If so, a blank tabulation form is inserted into the card input slot 26 and tabulated voting data printed on the tabulation form. In some situations, the results for all races may be printed on a single tabulation form, but in other situations too many races or too many candidates may require a separate tabulation form for each race. In this case, steps 332 and 334 are repeated for each race, and the tabulation forms will be race specific as shown in the examples depicted in FIGS. 7A and 7B.

The completed tabulation forms may then be inserted into a conventional counting machine (not shown) capable of reading the voting data printed on the tabulation forms.

As shown in FIG. 6A, the supervisor control program 320 may further comprise the optional additional steps of inserting the completed tabulation form in the ballot box (step 350) and sealing the ballot box (step 352). The completed tabulation forms may be sealed in the ballot box with the completed ballot forms, or may be placed in a separate ballot box to enhance the validity of any subsequent audits. Steps 350 and 352 will help to create an audit trail as will be described in further detail below.

And as shown in FIG. 6B, the supervisor control program 320 may comprise the optional additional steps 360 and 362 to generate two sets of completed tabulation forms; in this case, one of the completed tabulation forms is inserted into the counting machine at step 336 and the other is sealed in the ballot box. These optional steps may be performed by printing the tabulation results at the same time on a two-part form that is subsequently separated into the first and second completed tabulation forms. Again, the blank tabulation cards may be serialized and printed on special paper with special ink to reduce counterfeiting.

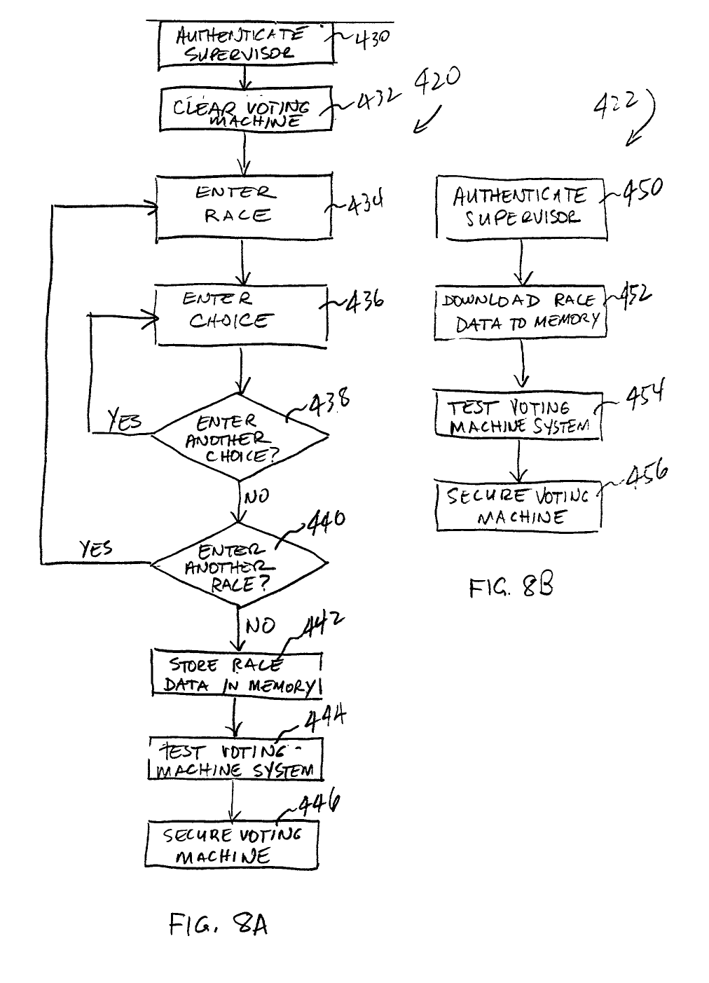

Referring now to FIGS. 8A and 8B, depicted therein are exemplary race data programs 420 and 422 that may be used to set up the kiosk system 20 for use as described above. In particular, each election day will have different races and different candidates. Accordingly, new race data must be entered each election.

The race data program 420 of FIG. 8A starts with the step 430 of authenticating the supervisor as described above. The system 20 is next cleared at step 432 by eliminating any data stored in the non-volatile memory 36, or this data may simply be overwritten.

The supervisor then at step 434 enters the first race and any data associated with that race. The race data includes a title (e.g., “U.S. President) and, if necessary, a description of the race. The race data may further include related information such as the wording of the confirmation message and/or the text of a voter initiative or the like.

The supervisor at step 436 then enters the first choice for that race. The choice may have associated choice data as allowed by appropriate law. For example, candidates for elected office may have their name, a statement, a color picture, or the like entered at this step 436. Then, when the race screen is displayed at step 230 in the voting process, the appropriate picture, statement, or the like is displayed to help the voter make the selection.

Step 436 is repeated by the decision at step 438 until all of the choices for a particular race have been entered. The program then moves to step 440, which repeats steps 434, and steps 436 and 438, until all of the races have been entered.

The race data and choice data are then stored in the non-volatile memory at step 442. The kiosk system 20 is then tested at step 446 and secured at step 448 until the supervisor program 320 is run.

As an alternate to the program 420, the program 422 may be run by the system 20. In this program 420, steps 434-440 of the program 420 are run on a separate general purpose computer by the election overseer. The general purpose computer has data ports that may be connected to scanners, digitized cameras, and the like. This will enable the overseer to enter the more sophisticated race and choice data described above without making the kiosk system 20 unnecessarily complicated. In this case, the race and choice data is then loaded onto removable non-volatile memory devices that are distributed in a controlled fashion to supervisors at individual polling or voting places. The non-volatile memory device is inserted into the kiosk system 20 at step 452, after which the kiosk system 20 is tested at step 454 and secured at step 456.

The securing step identified by reference characters 448 and 456 in the programs 420 and 422 is optional and may be as simple as setting a software lock that can be opened only by a supervisor that successfully performs the authentication step 322 described above. When more security is desired, the securing step may also include the step of forming a tamper seal on any portion of the kiosk system 20 that may be opened or removed. Thus, if the kiosk system 20 is modular with a removable printer, hard drive, or the like, the tamper seal is formed across a seam formed between the housing 22 and the removable component such that the tamper seal must be broken if the removable component is removed. The securing step may optionally comprise detachably attaching a cover (not shown) to the housing 22 that covers all input and output devices and is protected by a tamper seal. The tamper seal would be broken by the supervisor at the polling place immediately before voting starts.

Tamper seals are conventional and will not be described herein in detail. Examples of appropriate tamper seals include an adhesive strip, stamped lead or wax fastener, or one way plastic fastener such as a strap tie. Any of these tamper seals would have a unique design and would be manufactured and distributed in a controlled fashion to ensure that only election officials had access to the tamper seal of the unique design. A common characteristic of such tamper seals is that they must be destroyed to access the removable component and cannot be replaced by people who are not properly in possession of the unique type of tamper seal. Serial numbers and the like may be used to track the tamper proof seals.

In addition to the various configurations of voting kiosk systems 20 described above, the voting kiosk may be configured in yet another configuration referred to herein as a secure kiosk system. The race and choice data of a secure kiosk system is programmed and accessible only via master control input system that may be similar to, or formed by, the input slot 26, output slot 28, and card reader 38 described above. Only election officials such as the election overseer would create master control cards that are inserted into the master control input system. The master control cards would contain all of the race and choice data and would be distributed to all precincts or polling places. The supervisor at the precinct switches each kiosk into supervisor mode and runs a race data program similar to the program 422 described above, but substitutes the step of inserting the master race card into the mater control input system for the step of installing the non-volatile memory device.

Using the voting process described above provides a number of ways to audit and thus validate election results. First, the use of the tabulation cards allows election officials to quickly and accurately determine the outcome of the various races. These results are essentially “instant” and can be communicated directly to a higher office for compilation with the results of other precincts.

Second, the completed ballot forms can be optically recounted using a conventional optical counting machine (not shown). This optical recount can read one or the other of the plain language or bar code representations or, better yet, both of these so that a comparison can be made to validate the data.

Third, because the voting data is printed on the cards in plain language, the completed ballot cards can easily be inspected and counted by hand during a hand recount process if required.

Fourth, any missing or added ballots can be detected by comparing the tabulation data with the data generated by counting the individual ballots either by hand or by using a optical counting system. In this context, the number of ballots generated by each kiosk may be printed on the tabulation form generated by that kiosk.

The use of permanent, non-changeable indelible ink enhances the security of this process. In addition, the ink may be made of a special formulation and the ballot and tabulation forms themselves may be printed on special stock with special ink to help thwart counterfeiting of completed ballot forms.

From the foregoing, it should be clear that the present invention may be embodied in forms other than those described above. The above-described systems and methods are therefore to be considered in all respects illustrative and not restrictive.

I claim:

1. A voting system for allowing voters to select one of a plurality of choices associated with at least one race associated with an election, comprising:
a blank ballot form issued to each voter;
a kiosk system comprising an output device, an input device, a tabulation system, a memory device, and a printer; and
a blank tabulation form associated with the kiosk system; whereby the memory device stores race data and choice data associated with the races and choices of the election, selection data, and tabulation data;
the output device is controlled to communicate the race data and the choice data to the voters;
the input device is controlled to receive the selection data from the voters;
the tabulation system generates the tabulation data associated with the kiosk system based on the selection data;
the printer generates completed ballot forms by printing the selection data of each voter on the blank ballot form issued to each voter, and
a completed tabulation form by printing the tabulation data generated for the kiosk system on the blank tabulation form; and
the selection data on the completed ballot forms and tabulation data on the completed tabulation forms may be compared to audit results of the election.

2. A voting system as recited in claim 1, in which:
the output device is selected from the group of output devices consisting of a video screen, a touch screen, a tactile feedback system, and an audio system; and
the input device is selected from the group of input devices consisting of a touch screen, a voice input system, a tactile input system, an eye tracking system, and a keyboard.

3. A voting system as recited in claim 1, in which:
the output device is additionally controlled to display confirmation data; and
the input device is additionally controlled to receive confirmation instructions, where the printer does not generate the completed ballot forms until after the confirmation instructions are received.

4. A voting system as recited in claim 1, in which the printer prints the selection data on the completed ballot forms and tabulation data on the completed tabulation forms in a language understandable by the voter.

5. A voting system as recited in claim 4, in which the printer also prints the selection data on the completed ballot forms and tabulation data on the completed tabulation forms in a code readable by an optical counting machine.

6. A voting system as recited in claim 1, in which each blank ballot form has a unique ballot serial number imprinted thereon.

7. A voting system as recited in claim 6, in which the ballot serial number associated with the completed ballot forms generated by the kiosk system is printed on the completed tabulation form generated by the kiosk system.

8. A voting system as recited in claim 1, in which:
a blank tabulation form is associated with the kiosk system for each race in the election; and
the printer generates a completed tabulation form for each race by printing the tabulation data generated by the kiosk system for each race on the blank tabulation form associated with each race.

9. A voting system as recited in claim 1, further comprising a plurality of voting kiosk systems each having a unique kiosk serial number associated therewith, where the kiosk serial number of a given one of the kiosk systems is printed on each completed ballot form generated by the given one of the kiosk systems.

10. A voting system as recited in claim 1, in which the kiosk system operates in a voting mode and in a supervisor mode, the kiosk system further comprising an authentication system for authenticating whether a user of the kiosk system is authorized to operate the kiosk system in the supervisor mode.

11. A voting system as recited in claim 10, in which the printer generates the completed tabulation form only when the kiosk system is in the supervisor mode.

12. A voting system as recited in claim 10, in which the race data and choice data may be stored in the kiosk system only when the kiosk system is in the supervisor mode.

13. A voting system as recited in claim 1, in which the kiosk system further comprises a verification system for verifying that each blank ballot form inserted into the kiosk system is authentic.

14. A voting system as recited in claim 1, further comprising a tamper seal for limiting access to the kiosk system.

15. A voting system as recited in claim 1, in which the printer prints time data on the completed ballot form to facilitate auditing of results of the election.

16. A voting system as recited in claim 1, in which:
the kiosk system further comprises an optical reader; and
the voting system further comprises a master control card containing the race data and choice data; whereby
the optical reader reads the race data and choice data from the master control card and stores the race data and choice data in the memory device.

17. A method of allowing voters to select one of a plurality of choices associated with at least one race associated with an election, comprising the steps of:
issuing a blank ballot form to each voter;
providing a kiosk system comprising an output device, an input device, and a printer;
associating a blank tabulation form with the kiosk system;
controlling the output device to communicate race data and choice data to the voters;
controlling the input device to receive selection data from the voters;
generating tabulation data associated with the kiosk system based on the selection data;
controlling the printer to generate completed ballot forms by printing the selection data of each voter on the blank ballot form issued to the voter, and
a completed tabulation form by printing the tabulation data generated for the kiosk system on the blank tabulation form; and
auditing results of the election by comparing the selection data on the completed ballot forms with the tabulation data on the completed tabulation forms.

18. A method as recited in claim 17, further comprising the steps of:
selecting the output device from the group of output devices consisting of a video screen, a touch screen, a tactile feedback system, and an audio system; and
selecting the input device from the group of input devices consisting of a touch screen, a voice input system, a tactile input system, an eye tracking system, and a keyboard.

19. A method as recited in claim 17, further comprising the steps of:
controlling the output device to display confirmation data; and
controlling the input device to receive confirmation instructions, where the printer does not generate the completed ballot forms until after the confirmation instructions are received.

20. A method as recited in claim 17, further comprising the step of printing the selection data on the completed ballot forms and tabulation data on the completed tabulation forms in a language understandable by the voter.

21. A method as recited in claim 20, further comprising the step of printing the selection data on the completed ballot forms and tabulation data on the completed tabulation forms in a code readable by an optical counting machine.

22. A method as recited in claim 17, further comprising the step of imprinting a unique ballot serial number on each blank ballot form.

23. A method as recited in claim 18, further comprising the step of printing the ballot serial number associated with the completed ballot forms generated by the kiosk system on the completed tabulation form generated by the kiosk system.

24. A method as recited in claim 17, further comprising the steps of:
associating a blank tabulation form with the kiosk system for each race in the election; and
generating a completed tabulation form for each race by printing the tabulation data generated by the kiosk system for each race on the blank tabulation form associated with each race.

25. A method as recited in claim 17, further comprising the steps of:
providing a plurality of voting kiosk systems;
associating a unique kiosk serial number with each of the voting kiosk systems; and
printing the kiosk serial number of a given one of the kiosk systems on each completed ballot form generated by the given one of the kiosk systems.

26. A method as recited in claim 17, further comprising the steps of:
operating the kiosk system in a voting mode and in a supervisor mode; and
authenticating whether a user of the kiosk system is authorized to operate the kiosk system in the supervisor mode.

27. A method as recited in claim 26, further comprising the step of generating the completed tabulation form only when the kiosk system is in the supervisor mode.

28. A method as recited in claim 26, further comprising the step of storing the race data and choice data in the kiosk system only when the kiosk system is in the supervisor mode.

29. A method as recited in claim 17, further comprising the step of verifying that each blank ballot form inserted into the kiosk system is authentic.

30. A method as recited in claim 17, further comprising the step of limiting access to the kiosk system using a tamper seal.

31. A method as recited in claim 17, further comprising the step of printing time data on the completed ballot form to facilitate auditing of results of the election.

32. A method as recited in claim 17, further comprising the steps of: providing a master control card containing the race data and choice data; reading the race data and choice data from the master control card; and storing the race data and choice data in the memory device.
